(19) United States
(12) Patent Application Publication
(10) Pub. No.: US 2013/0340318 A1
(43) Pub. Date: Dec. 26, 2013

(54) FISH BASKET COVER AND ASSEMBLY

(71) Applicant: Charles Martin Morici, Montauk, NY (US)

(72) Inventor: Charles Martin Morici, Montauk, NY (US)

(21) Appl. No.: 13/527,727

(22) Filed: Jun. 20, 2012

(51) Int. Cl. A01K 97/00

(52) U.S. Cl. 43/55

(57) ABSTRACT

The present invention provides a lid or cover which is dimensioned to fit properly over the open end of the fish basket, accommodating the integral handles. The lid or cover also provides means for stacking baskets one atop the other and provides supplemental drainage from one basket into the other. This means includes an upstanding cylinder dimensioned to snugly accommodate the bottom of a fish basket. The invention also covers the combination of two fish baskets separated by a lid according to the invention.

### FIELD OF THE INVENTION

This invention relates broadly to baskets for containing recently caught fish. More particularly, this invention relates to a cover for a fish basket that allows the baskets to be stacked safely and efficiently.

### STATE OF THE ART

Prior art FIGS. 1 and 2 show a “fish basket” 10 which is sold by “LinPac Ropak Packaging” and can be found at http://www.linpac.com/en/Products/Rigid-plastic-containers/40-LB-or-181-KG-Fish-Basket/. The basket is designed to contain approximately 70 lbs of fish. As can be seen in the drawings, it is perforate on the side 12 and the bottom 14 to allow water to drain. It is generally frustroconical in shape having dimensions of approximately 17″×19″. It weighs slightly over 4 lbs and has two integral, diametrically opposed handles 16, 18. It is a preferred container among professional fishermen. However, it has disadvantages.

### SUMMARY OF THE INVENTION

It is therefore an object of the invention to provide improvements to the above described “fish basket”.

In accord with this object, which will be discussed in detail below, the present invention provides a lid or cover which is dimensioned to fit properly over the open end of the fish basket, accommodating the integral handles.

The lid or cover also provides means for stacking baskets one atop the other and provides supplemental drainage from one basket into the other. This means includes an upstanding cylinder dimensioned to snugly accommodate the bottom of a fish basket.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of a prior art fish basket;

FIG. 2 is a side elevation view of the prior art fish basket;

FIG. 3 is a plan view of the bottom of a fish basket lid according to the invention;

FIG. 4 is a plan view of the top of a fish basket lid according to the invention;

FIG. 5 is a cross section along line A-A in FIG. 4; and

FIG. 6 is a side elevation view of two fish baskets stacked one atop the other with the invention there-between.

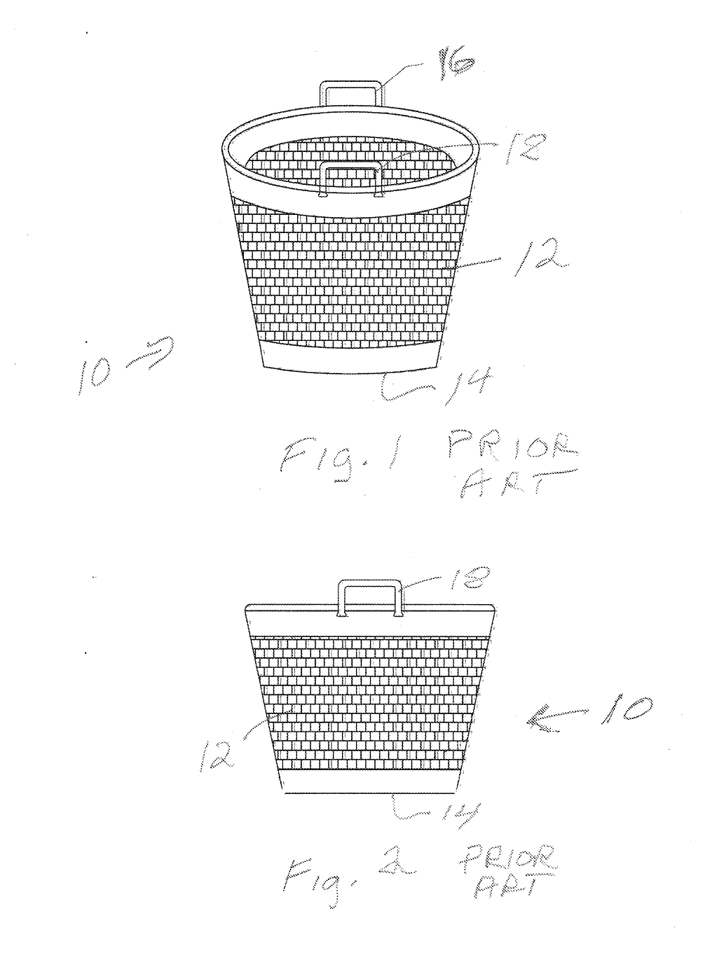

### DETAILED DESCRIPTION

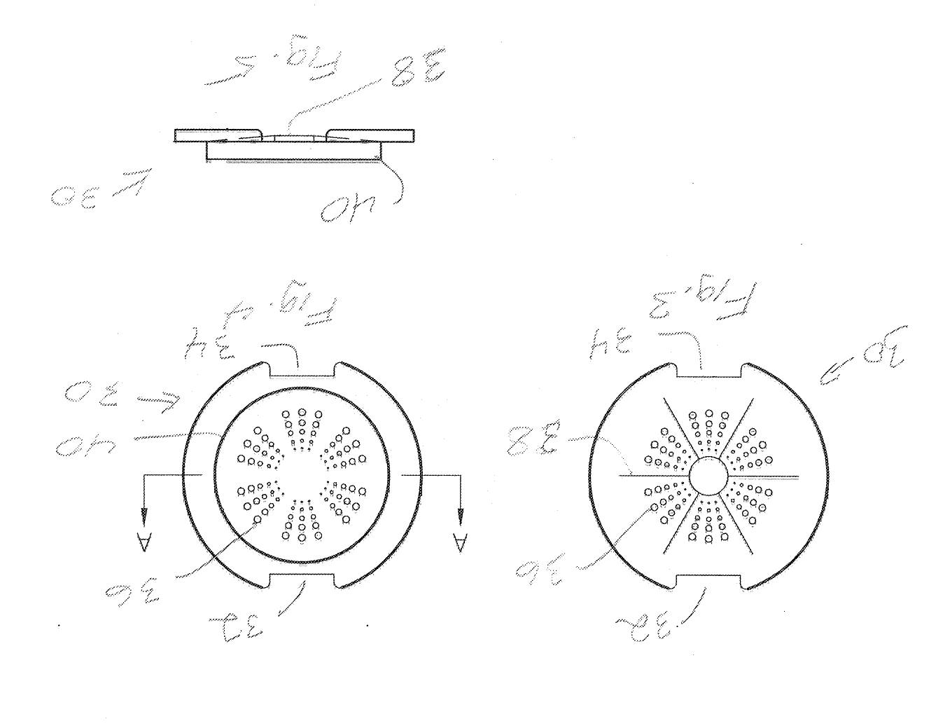

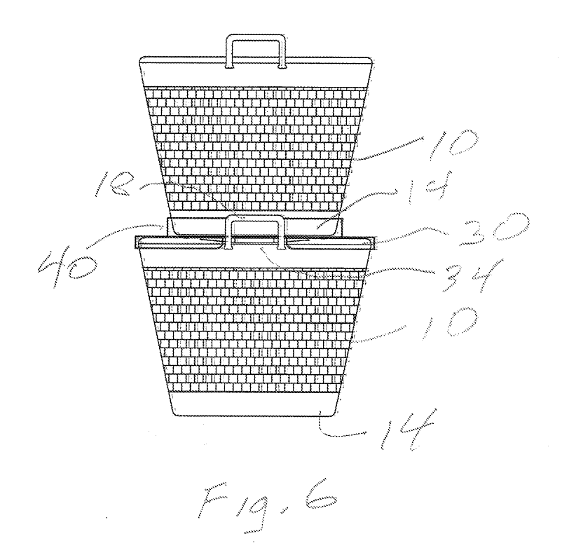

Turning now to FIGS. 3 through 5, the fish basket cover 30 according to the invention is essentially a disk having diametrically opposed substantially rectilinear cutouts 32, 34 and a plurality of drainage holes 36. A plurality of reinforcing ribs 38 are arranged on the bottom of the cover and an upstanding cylinder 40 is located on the top of the cover 30.

According to the presently preferred embodiment, the cover 30 is approximately twenty inches in diameter with a thickness of approximately one inch. The diametrically opposed cutouts 32, 34 are spaced approximately 16.75 inches apart and are each 5.5 inches wide. There are eighteen sets of drainage holes 36, each set comprising five holes of increasing diameter, e.g. ¼″, 5/16″, ⅜″, ½″, and 9/16″. The drainage holes are arranged substantially radially outward and arranged in six groups. There are six reinforcing ribs 38, each separating adjacent groups of drainage holes. The upstanding cylinder 40 is approximately 14.75 inches in diameter and approximately 1.5 inches tall.

Turning now to FIG. 6, the invention 30 can be seen separating two fish baskets 10 with the rectilinear cutouts (e.g. 34) accommodating the handles (e.g. 18). The upstanding cylinder 40 accommodates the bottom 14 of the upper basket 10. Although the drawing shows two baskets stacked, it will be appreciated that more than two could be stacked using additional covers according to the invention

There have been described and illustrated herein a fish basket cover and an assembly of fish baskets and covers. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A fish basket cover for use with a fish basket having two diametrically opposed handles at an upper end and a base at a lower end, said cover comprising:
a substantially circular disk having diametrically opposed cutouts designed to accommodate the handles of the basket and an upstanding cylinder rising from one side of the disk, said cylinder designed to accommodate the lower end of a basket.

2. The cover according to claim 1, further comprising:
a plurality of drainage holes extending through said disk.

3. The cover according to claim 2, further comprising:
a plurality of reinforcing ribs on the side of the disk opposite the upstanding cylinder.

4. The cover according to claim 3, wherein:
the reinforcing ribs are radially arranged and evenly spaced.

5. The cover according to claim 4, wherein:
the drainage holes are arranged in groups of increasing diameter.

6. An assembly, comprising:
two baskets, each having an upper end and a lower end, said upper end having two diametrically opposed handles;
a cover comprising a substantially circular disk having diametrically opposed cutouts designed to accommodate the handles of one of the two baskets and an upstanding cylinder rising from one side of the disk, said cylinder designed to accommodate the lower end of the other of said two baskets.

7. The assembly according to claim 6, the cover further comprising:
a plurality of drainage holes extending through said disk.

8. The assembly according to claim 7, the cover further comprising:
a plurality of reinforcing ribs on the side of the disk opposite the upstanding cylinder.

9. The assembly according to claim 8, the cover further comprising:
the reinforcing ribs are radially arranged and evenly spaced.

10. The assembly according to claim 9, the cover further comprising:
the drainage holes are arranged in groups of increasing diameter.
